(19) United States
(12) Patent Application Publication
(10) Pub. No.: US 2004/0123249 A1
(43) Pub. Date: Jun. 24, 2004

(54) Apparatus and method for estimating power consumption

(75) Inventors: Koichi Sato, Kanagawa (JP); Hiroshi Shibuya, Kanagawa (JP); Hitoshi Kurosaka, Kanagawa (JP)

Correspondence Address: McGinn & Gibb, PLLC, Suite 200, 8321 Old Courthouse Road, Vienna, VA, 22182-3817, US

(73) Assignee: NEC Electronics Corporation, Kanagawa (JP)

(21) Appl. No.: 10/623,575

(22) Filed: Jul. 22, 2003

(30) Foreign Application Priority Data
Jul. 23, 2002 (JP) 2002-213912

(51) Int. Cl. G06F 17/50

(52) U.S. Cl. 716/1; 716/4

(57) ABSTRACT

An apparatus for estimating power consumption includes an behavioral synthesizing unit and a clock-based simulation unit. The behavioral synthesizing unit is provided with an algorithm-level description as an input and converts the algorithm-level description to a clock-based description and behavioral synthesis information. The clock-based description and behavioral synthesis information are input to the clock-based simulation unit, which proceeds to execute a clock-based simulation and calculates a power consumption factor of a storage element based upon both the clock-based description and behavioral synthesis information.

### FIELD OF THE INVENTION

This invention relates to an apparatus and method for estimating hardware power consumption. More particularly, the invention relates to an apparatus and method for estimating power consumption in a system that implements a clock-based simulation.

### BACKGROUND OF THE INVENTION

There is a growing need to develop a multiprocessing system comprising an ASIC, CPU and memory, etc. Since it is required that such a system consume little power, power consumption is estimated after the system is designed. FIG. 2 illustrates the flow of a method of estimating power consumption according to the prior art.

First, an algorithm 1 that describes the processing operation of the overall system is input to an behavioral synthesis unit 2. The algorithm 1 expresses an ASIC (hardware). The behavioral synthesis unit 2 subjects the entered algorithm 1 to behavioral synthesis processing and converts it to RTL HDL (Register Transfer Level Hardware Description Language) 3. A simulation is then performed by an RTL HDL simulator 14 based upon the RTL HDL 3 to obtain the transition probabilities and toggle rates of variables that will serve as storage elements.

Logic synthesis 6 also is executed based upon the RTL HDL 3, gate assignment is carried out, a gate netlist 7 is generated and is input to a toggle rate-transition probability calculation unit 10. The toggle rate-transition probability calculation unit 10 sets toggle rate and transition probability in a gate storage element based upon the input information, calculates toggle rates and transition probabilities of gates other than storage elements and calculates the toggle rates and transition probabilities of all gates. Furthermore, gate-level power consumption is calculated by a gate-level power consumption calculation unit 13 based upon toggle rates and transition probabilities 11 of all gates and a gate library 12.

On the other hand, clock-based simulation techniques have been proposed in order to construct a simulation model capable of performing simulations in greater detail than with simulations based upon algorithm-level description and at a speed higher than that of RTL HDL. For example, a clock-based simulation technique has been disclosed in the specification of Japanese Patent Kokai Publication No. JP-P2001-109788A and in the technical report “C++ Simulator for “ClassMate” for pre-verification on SOC” (by Hidefumi Kurokawa, Technical Report of IEICE, VLH98-46), the entire description of there two publications being incorporated herein by reference thereto. With clock-based simulation, a simulation is executed based upon a clock-based description. A clock-based description has a lower level of abstraction than algorithmic language and a higher level of abstraction than RTL HDL.

### SUMMARY OF THE DISCLOSURE

A method of estimating power consumption premised on RTL HDL simulation according to the prior art updates the values of all gates every cycle regardless of whether the value of a storage element changes. As a consequence, simulation speed is low and it is difficult to estimate power consumption in a short time. Further, since the level of abstraction is not raised and operation is not simplified in regard to buses, simulation speed is low.

Accordingly, an object of the present invention is to provide a power-consumption estimating apparatus and method that makes it possible to estimate power consumption at high speed and precision.

According to the present invention, the foregoing object is attained by providing an apparatus for estimating power consumption, comprising: an behavioral synthesis unit to which an algorithm-level description is input for converting the algorithm-level description to a clock-based description and behavioral synthesis information; and a clock-based simulation unit to which the clock-based description and behavioral synthesis information are input for executing a clock-based simulation and calculating a power consumption factor of a storage element based upon both the clock-based description and behavioral synthesis information. This arrangement makes it possible to estimate power consumption at higher speed and precision.

In connection with the calculation of the power consumption factor of a storage element, it is preferred that the factor be calculated by discriminating the type of the storage element using the behavioral synthesis information in regard to an array-variable part. The type of storage element can be discriminated based upon the behavioral synthesis information and estimation of power consumption can be automated.

Further, the power consumption factor in a preferred embodiment is toggle rate and/or transition probability.

Preferably, correspondence between RT (Register Transfer) variable names and gates is assumed from the behavioral synthesis information, and after toggle rates and/or transition probabilities are set in gate circuits, the toggle rates and/or transition probabilities of all gate circuits are calculated.

In particular, if the system has a gated clock, the clock toggle rate and/or transition probability should be made the same as the write probability with respect to a storage element.

Further, the foregoing object of the present invention is attained by providing a method of estimating power consumption, comprising the steps of: inputting a clock-based description and behavioral synthesis information; executing a clock-based simulation based upon the clock-based description; and calculating a power consumption factor based upon both the clock-based description and behavioral synthesis information. This arrangement makes it possible to estimate power consumption at higher speed and precision.

In connection with the calculation of the power consumption factor of a storage element, it is preferred that the factor be calculated by discriminating the type of the storage element using the behavioral synthesis information in regard to an array-variable part. The type of storage element can be discriminated based upon the behavioral synthesis information and estimation of power consumption can be automated.

Further, the power consumption factor in a preferred embodiment is toggle rate and/or transition probability.

It is preferred that correspondence between RT variable names and gates is assumed from the behavioral synthesis information, toggle rates and/or transition probabilities are set in gate circuits, and thereafter the toggle rates and transition probabilities of all gate circuits are calculated.

In particular, if the system has a gated clock, the clock toggle rate and/or transition probability should be made the same as the write probability with respect to a storage element.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram illustrating the flow of a method of estimating power consumption according to the present invention;

FIG. 2 is a diagram illustrating the flow of a method of estimating power consumption according to the prior art;

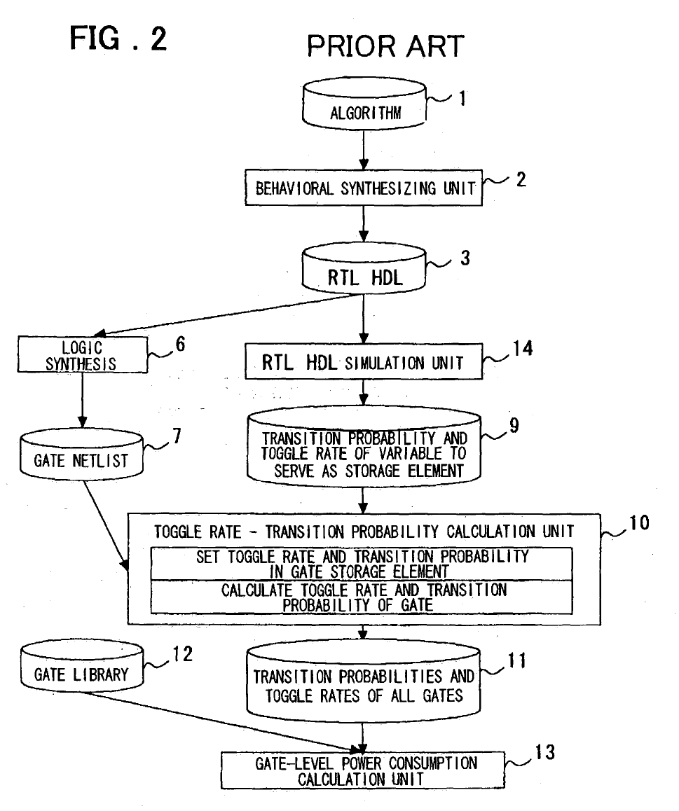

FIG. 3 is a diagram illustrating an example of an algorithm-level description;

FIG. 4 is a diagram illustrating an example of state transition diagram;

FIG. 5 is a data flow graph using algorithm variables;

FIG. 6 is a data flow graph using register variables;

FIG. 7 is a diagram showing the structure of a synthesizable RTL circuit;

FIGS. 8A and 8B are diagrams useful in describing setting of toggle rate and transition probability in a register;

FIGS. 9A, 9B and 9C are diagrams useful in describing setting of toggle rate and transition probability of an array;

FIG. 10 is a diagram illustrating an example of behavioral synthesis information; and

FIG. 11A is a diagram useful in describing a circuit that does not employ a gated clock, and FIG. 11B is a diagram is useful in describing a circuit that does employ a gated clock.

### PREFERRED EMBODIMENTS OF THE INVENTION

A preferred embodiment of the present invention will now be described in detail with reference to the drawings.

The method of estimating power consumption according to the present invention uses toggle rate and transition probability as information for the purpose of estimating power consumption. Toggle rate and transition probability will be described first.

Toggle rate indicates what part of overall simulation time (number of cycles in which a clock serves as the reference) is occupied by the rate at which a value changes as from 1 to 0 or 0 to 1. For example, if there is a change from 1 to 0 and further from 0 to 1, i.e., if a value undergoes a round trip between 1 and 0, this is calculated as a single toggle. In this case, if there is a toggle every cycle of all cycles, then the toggle rate will be 0.5. However, how a single toggle is defined is optional. Toggle rate influences the part of consumed power that is switching power.

Transition probability is the probability that a 1 or 0 value exists among variables. For example, in a case where the time over which a variable indicates 1 in an overall simulation, namely time over which a transistor is ON, is half the overall simulation time, the transition probability is 0.5. Transition probability influences leakage power.

In this embodiment of the present invention, an example in which both toggle rate and transition probability are used as information for estimating power consumption will be described. However, either of these items of information is sufficient and equivalent information other than these items of information may be included. Furthermore, the present invention is applicable even in a case where power consumption is estimated based solely upon information other than toggle rate and transition probability.

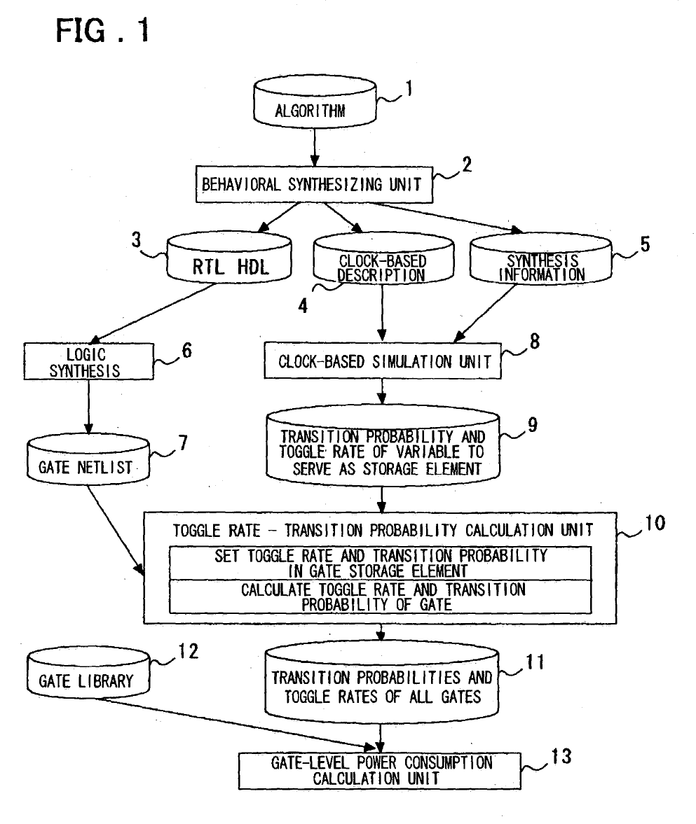

FIG. 1 illustrates the flow of a method of estimating power consumption according to this invention.

As shown in FIG. 1, the algorithm 1 that describes the processing operation of the overall system is input to the behavioral synthesis unit 2. The algorithm 1 expresses an ASIC (hardware). In general, an algorithm-level description is expressed by C language or C++ language, which is a programming language.

The behavioral synthesis unit 2 subjects the entered algorithm 1 to behavioral synthesis processing and converts it to RTL HDL 3, a clock-based description 4 and synthesis information 5. A method of converting the algorithm 1 to the clock-based description 4 is described in the specification of Japanese Patent Kokai Publication No. JP-P2001-109788A, the entire description thereof being incorporated herein by reference thereto.

The clock-based description 4 and synthesis information 5 are input to a clock-based simulation unit 8. The latter executes a clock-based simulation. Here the clock-based description is a description having a higher level than that of RTL HDL and a lower level than that of an algorithm-level description. The clock-based simulation unit 8 therefore is capable of executing a simulation at a higher speed than that of an HDL simulation executed by the RTL HDL simulator 14 of the prior art. The simulation time of a clock-based description is approximately 1/500 the simulation time of the RTL HDL simulation, though this depends upon the content of the algorithm.

In the clock-based simulation, toggle rate and transition probability of a variable to serve as a storage element are calculated. More specifically, while the state of a variable corresponding to a storage element is traced, the toggle rate and transition probability are calculated. For example, assume that a value such as Reg1=“0010” has changed to a value such as Reg1=“0000”. With a clock-based description, it is possible to have bit-by-bit information with regard to a variable and therefore the fact that only the flip-flop corresponding to the second bit has changed and that bits other than this bit have not changed can be discriminated. Transition probability can also be similarly calculated with respect to all bits. The calculation mechanism for calculating toggle rate and transition probability is added onto the clock-based description anew. In the prior art, this part calculates the toggle rate and transition probability of a register using RTL HDL simulation. However, RTL HDL simulation is slow in speed and calculation can be performed much faster with clock-based simulation.

Hence, if an instance name Reg1, which is a 4-bit register that can be nothing but a register, becomes a gate circuit owing to logic synthesis, Reg1 changes as follows:

Reg1→0^{th} bit Reg1_reg0

1st bit Reg1_reg1

2^{nd} bit Reg1_reg2

3^{rd} bit Reg1_reg3

Thus, Reg1 is such that the instance name of the gate changes systematically (according to a rule) in the following manner:

RTL variable name_reg bit number

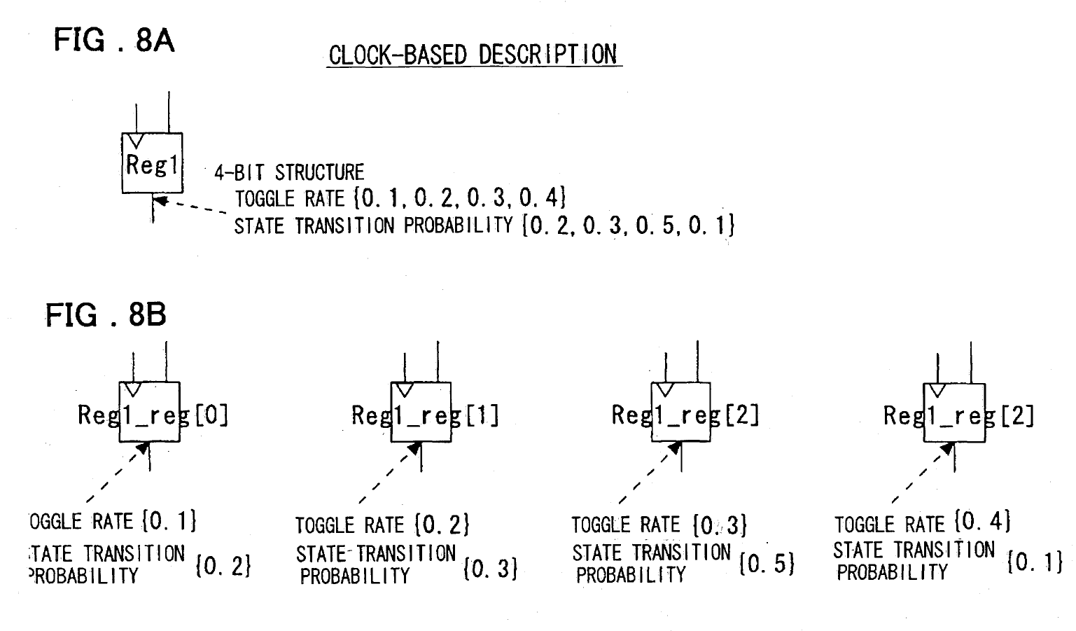

Accordingly, it is possible to determine which register variable will be what flip-flop of the gate. The toggle rates and transition probabilities of registers in a clock-based description obtained on bit-by-bit basis, as shown in FIG. 8A, can be assigned to four gate-level flip-flops, as indicated in FIG. 8B.

In the case of a logic synthesis apparatus in which the names of gate variables are not created in this manner, however, it may not be possible to adopt matching of names. In such case the user sets the toggle rate and transition probability with regard to a flip-flop for which toggle rate and transition probability could not be set.

When the toggle rate and transition probability of a storage element are calculated, a clock-based simulation uses the behavioral synthesis information 5, which has been generated by the behavioral synthesizing unit 2, to process (determine) an array variable for which it cannot be determined merely by the clock-based description whether the variable pertains to a memory or a register. This processing constitutes a characterizing feature of the present invention and will be described in detail later.

In addition to the foregoing, a clock-based simulation performs verification of clock-based operating timing of each module, general verification of the interfaces of each module, frequency estimation of the operating clock of each module and bus, estimation of cache access and estimation of access such as bus occupancy rate.

Further, as shown in FIG. 1, logic synthesis 6 also is executed based upon RTL HDL 3, gate assignment is carried out and the gate netlist 7 is produced. The gate netlist 7 produced is input to the toggle rate-transition probability calculation unit 10. Also input to the toggle rate-transition probability calculation unit 10 are the calculated toggle rate and transition probability 9 of the variable that will serve as the storage element, these being obtained from the clock-based simulation unit 8. On the basis of this input information, the toggle rate-transition probability calculation unit 10 sets toggle rate and transition probability in a gate storage element and calculates toggle rates and transition probabilities 11 of gates. That is, the toggle rate transition probability calculation unit 10 causes values of toggle rate and transition probability to propagate from storage elements such as registers or memories and calculates the toggle rates and transition probabilities of gates in the remaining combinational circuits. Furthermore, gate-level power consumption is calculated by the gate-level power consumption calculation unit 13 based upon these toggle rates and transition probabilities 11 and the gate library 12. When power consumption is calculated, use is made of the library, which has gate logic information and power information. Here power consumption is calculated with the toggle rate and transition probability influencing switching power and leakage current, respectively.

Power consumption calculated in the manner described above has exactly the same accuracy when compared with the method of calculating power consumption from an RTL HDL simulation. The clock-based simulation is advantageous in that it has a higher speed than the RTL HDL simulation.

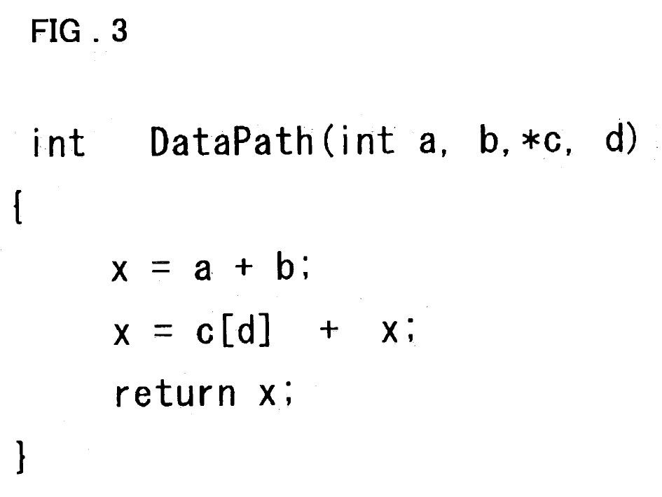

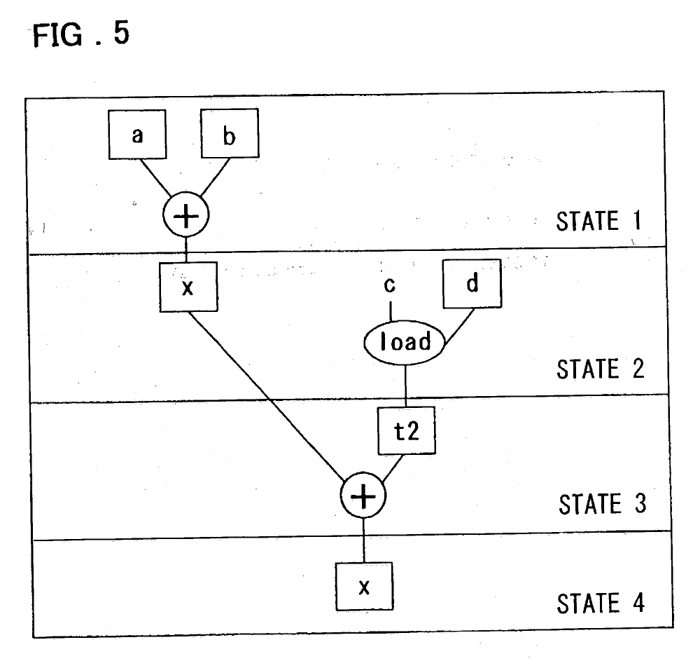

A method of estimating power consumption will be described based upon a specific example. FIG. 3 shows an example of a description of algorithm 1. The algorithm-level description depicted in FIG. 3 is converted to the clock-based description 4 by the behavioral synthesizing unit 2. At this time, behavioral synthesis is performed upon inputting a limiting condition of resources, which constitute a circuit, in addition to the algorithm-level description. The limiting condition of resources is, e.g., four registers and one adder. The algorithm-level description shown in FIG. 3 includes five variables a, b, c, d, x and two addition operations. The behavioral synthesizing unit 2 performs a state assignment in a data flow graph of the kind shown in FIG. 5 by behavioral synthesis scheduling. In state 1, a and b are summed using an adder and the result is substituted into x. In state 2, loading of array c[d] is performed and the result is substituted into t2. In state 3, x and t2 are summed using the same adder as that which summed a and b, and the result is substituted into x again. A variable that exists at a cycle boundary is then assigned to a register. Since it is necessary to hold the value at a cycle boundary, such a variable is assigned to a register.

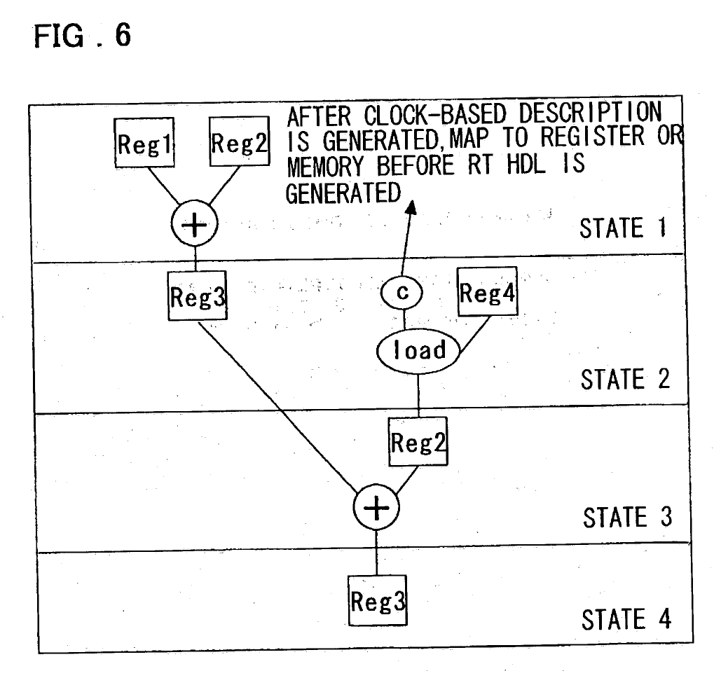

FIG. 6 is a data flow graph after register assignment is carried out. In state 1, variable a is assigned to Reg1 and variable b is assigned to Reg2. In state 2, variable x is assigned to Reg3 and variable d is assigned to Reg4. In state 3, variable t2 is assigned to Reg2. That is, variables b and t2 share Reg2.

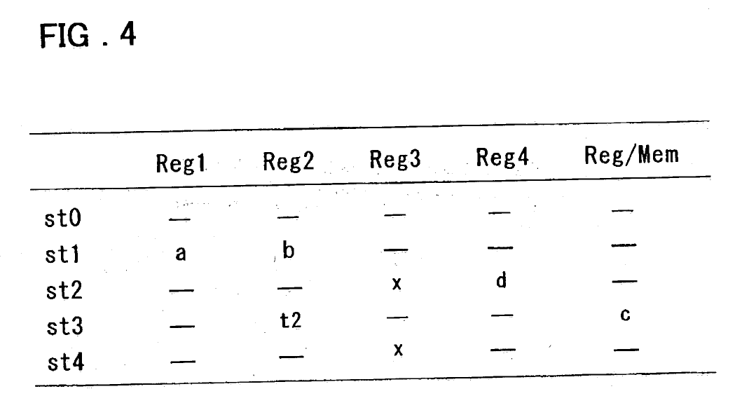

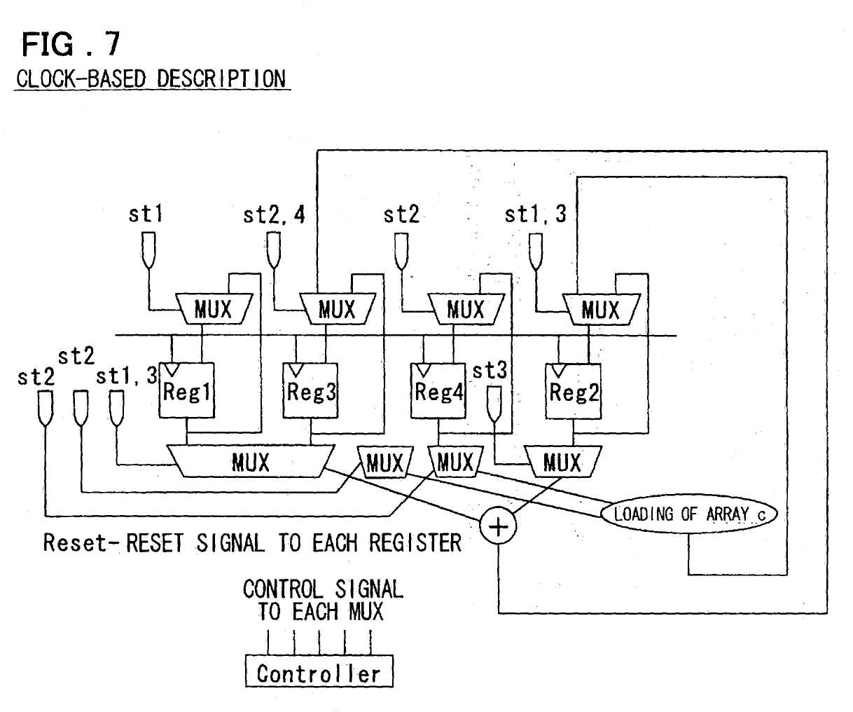

FIG. 4 is a table illustrating the relationship among variables, registers and states in this example. In the table of FIG. 4, st0 to st4 correspond to states 0 to 4, respectively. State 0 has been created as the initial state, as indicated in FIG. 4. In state 1, register Reg1 holds the value of variable a and register Reg2 holds the value of variable b. In state 2, register Reg3 holds the value of variable x and register Reg4 holds the value of variable d. In state 3, register Reg2 holds the value of variable t2 and register Reg or memory (Reg/Mem) holds the value of variable c. As mentioned above, whether the array variable c pertains to a memory or register cannot be determined merely by the clock-based description. In state 4, register Reg3 possesses the value of variable x. An RT circuit shown in FIG. 5 can be created based upon the table shown in FIG. 4. If the clock-based description is expressed by a circuit, the result will be as shown in FIG. 7. The hardware configuration based upon this clock-based description is formed from four registers and eight multiplexers.

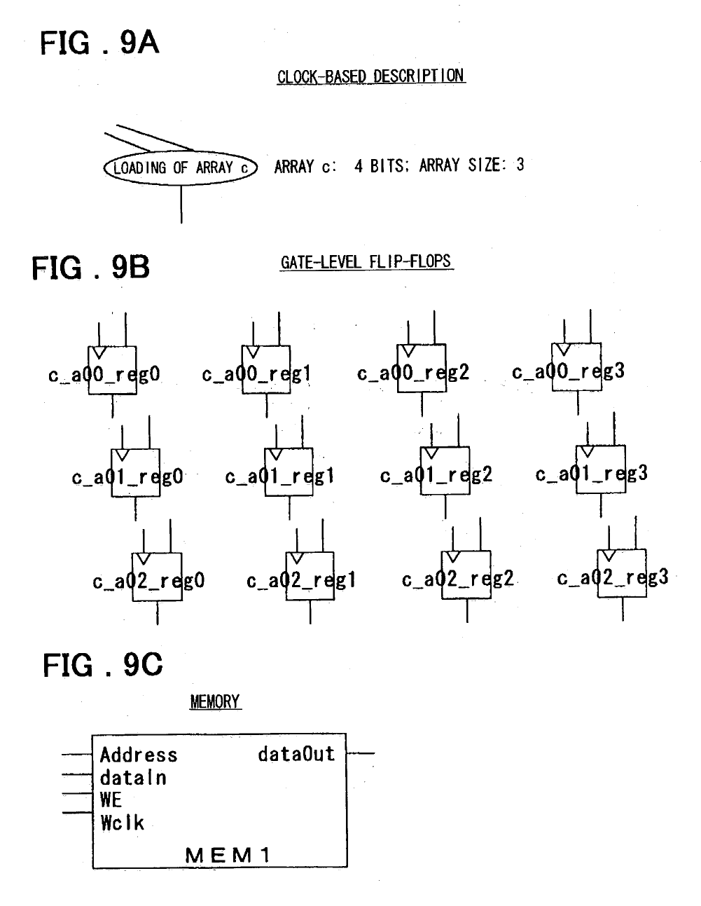

Processing relating to the array variable will be described in detail next. Whether the array variable is a memory or flip-flop (register) cannot be determined, as set forth above. FIGS. 9A, 9B and 9C illustrate examples of an array variable. FIG. 9A is an example of a clock-based description, FIG. 9B shows an example of a case where the variable is assumed to be a gate-level flip-flop, and FIG. 9C shows an example of a case where the variable is assumed to be a memory.

In the case of array c shown in FIG. 9A, whether the variable is a register or memory can be determined from the synthesis information 5. In case of the register (flip-flop), toggle rate and transition probability are calculated for every bit of the array index and elements.

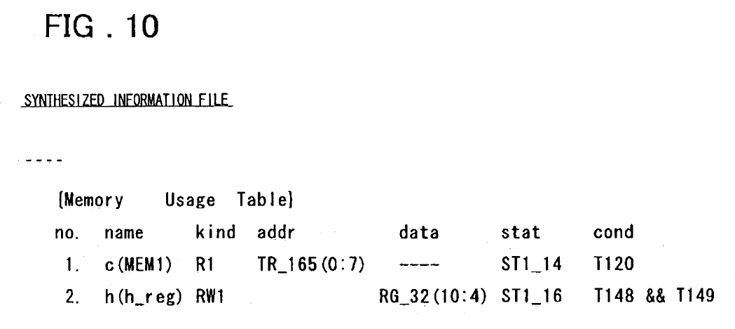

In the case of the memory, first it is discriminated by which memory instance the array has been implemented in the gate level. An behavioral-synthesis information file shown in FIG. 10 is used in the discrimination. In the behavioral-synthesis information file shown in FIG. 10, it is described that the variable c is mapped to the memory MEM1. Further, it is described that the variable h is mapped to the register h_reg. With regard to h_reg at this time, it is assumed that this corresponds to a register based upon the suffix _reg.

Accordingly, in the case of the example shown in FIG. 10, the array c is expressed by the memory instance name MEM1 and it can be determined that the variable is a memory. That is, the array c is constructed as shown in FIG. 9C. In the structure depicted in FIG. 9C, Address, dataIn and dataOut correspond to the index of the array, the input data and the output data, respectively. Further, WE indicates memory read and write, and Wclk indicates the memory is made active or inactive. What these signals should be and, in particular, whether the memory is active or inactive, are not set forth in the clock-based description. Accordingly, it is so arranged that the behavioral synthesizing unit 2 sets the signals upon assuming what the tendency of HDL creation will be at the same time as the clock-based description.

The behavioral synthesizing unit 2 used in this embodiment creates HDL that always implements the read operation of the memory even when read is unnecessary. Accordingly, the behavioral synthesizing unit 2 assumes signals such that Read acts as WE=0 and Write as WE=1 and such that Wclk is active at all times. Alternatively, it may be so arranged that synthesis information in which behavioral synthesis is unclear is left in the file and this information is used.

By thus using both a clock-based description and behavioral synthesis information, the toggle rate and transition probability of an array that will be a memory can be assigned to the memory of a gate circuit.

The above-described assumption (estimating) processing may be summarized as follows:

(1) In case of a clock-based description, there are occasions where it cannot be determined whether a variable that will become a storage element will be a register (flip-flop) or memory. In the case of RTL HDL, it can be clearly determined that the variable will be a memory because this is described by a component.

(2) The set information of the toggle rate and transition probability changes depending upon whether the variable is a register or memory. Thus it is necessary to know the type of the memory (storage) element.

(3) Behavioral synthesis information is used for the purpose of assumption processing.

With the method of estimating power consumption according to this embodiment, as described above, power consumption is calculated from the toggle rates and transition probabilities of storage elements in an ASIC computed by a clock-based simulator. This makes it possible to calculate power consumption at a higher speed, and with equivalent accuracy, in comparison with the conventional method of calculating the toggle rates and transition probabilities of storage elements in an ASIC using an RTL HDL simulation according to the prior art. The reason for this is that with a clock-based simulation, only registers whose values have changed are updated, unlike the case with the RTL HDL simulation. Since the level of abstraction is high with regard to the buses, high-speed estimation can be achieved.

Processing in a case where a gated clock is used will be described next.

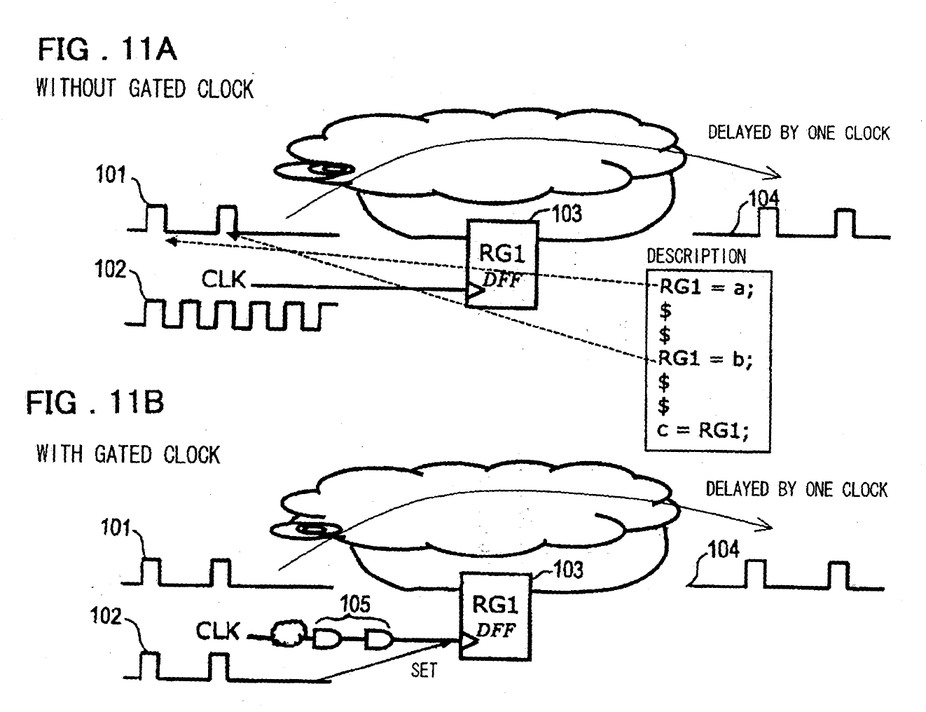

FIG. 11A is a diagram illustrating processing in the absence of a gated clock. FIG. 11A exemplifies an arrangement in which a register 103 has been connected to a combinational circuit. A data signal 101 and a clock signal 102 are input to the register 103. The latter outputs a data signal 104. The clock-based description in this case is as illustrated. In the description, the symbol “$” signifies demarcation of the clocks. Accordingly, this description means first writing a to register RG1, writing b to register RG1 two clocks later, and reading out c a further two clocks later. If there is no gated clock, the clock signal 102, which turns on and off repeatedly, is input to the register 103, as illustrated in FIG. 11A, as a result of which power consumption is high. Since it is unnecessary to activate the clock in a case where there is no writing of a signal, a gated clock is used as means for reducing power consumption in order to halt the clock when then clock is unnecessary.

FIG. 11B is a diagram illustrating processing when a gated clock is employed. In this case, a gate circuit 105 is provided at the input of the clock signal. In behavioral synthesis, a gated clock based upon the gate circuit 105 is created. The gate circuit 105 is a circuit to which the clock is supplied at write time. Since the behavioral synthesizing unit 2 creates a gated clock to halt power only at write time, the transition probability and toggle rate of the clock are calculated by making them the same as the write probability of the register. In a case where a gated clock does not perform this operation, it is necessary to hypothesize a wave shape adapted to conform to the characteristic and to set the toggle rate and transition probability.

The meritorious effects of the present invention are summarized as follows.

In accordance with the present invention, it is possible to provide an apparatus and method through which power consumption can be estimated at high speed and accuracy.

The reason for this is that with a clock-based simulation, only registers whose values have changed are updated, unlike the case with the RTL HDL simulation, and since the level of abstraction is high with regard to the buses, high-speed estimation can be achieved. Moreover, an equivalent accuracy is achieved because toggle rate and transition probability relating to storage elements similar to those of the conventional technique are obtained.

As many apparently widely different embodiments of the present invention can be made without departing from the spirit and scope thereof, it is to be understood that the invention is not limited to the specific embodiments thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An apparatus for estimating power consumption, comprising:
an behavioral synthesis unit to which an algorithm-level description is input for converting the algorithm-level description to a clock-based description and behavioral synthesis information; and
a clock-based simulation unit to which the clock-based description and behavioral synthesis information are input for executing a clock-based simulation and calculating a power consumption factor of a storage element based upon both the clock-based description and behavioral synthesis information.

2. The apparatus according to claim 1, wherein the power consumption factor of the storage element is calculated by discriminating the type of the storage element using the behavioral synthesis information in regard to an array-variable part.

3. The apparatus according to claim 1, wherein the power consumption factor is toggle rate and/or transition probability.

4. The apparatus according to claim 2, wherein the power consumption factor is toggle rate and/or transition probability.

5. The apparatus according to claim 1, wherein correspondence between RT variable names and gates is assumed from the behavioral synthesis information, and toggle rates and/or transition probabilities are set in gate circuits, thereafter the toggle rates and/or transition probabilities of all gate circuits being calculated.

6. The apparatus according to claim 3, wherein if a gated clock is provided, the toggle rate and/or transition probability of a clock are made the same as the write probability with respect to a storage element.

7. A method of estimating power consumption, comprising the steps of:
inputting a clock-based description and behavioral synthesis information;
executing a clock-based simulation based upon the clock-based description; and
calculating a power consumption factor based upon both the clock-based description and behavioral synthesis information.

8. The method according to claim 7, further comprising a step of calculating power consumption factor of the storage element by discriminating the type of the storage element using the behavioral synthesis information in regard to an array-variable part.

9. The method according to claim 7, wherein the power consumption factor is toggle rate and/or transition probability.

10. The method according to claim 8, wherein the power consumption factor is toggle rate and/or transition probability.

11. The method according to claim 9, further comprising the steps of assuming correspondence between RT variable names and gates from the behavioral synthesis information and, setting toggle rates and/or transition probabilities in gate circuits, and, thereafter, calculating the toggle rates and transition probabilities of all gate circuits.

12. The method according to claim 9, wherein if a gated clock is provided, the toggle rate and/or transition probability of a clock are made the same as the write probability with respect to a storage element.
